(19) United States
(12) Patent Application Publication
(10) Pub. No.: US 2024/0391062 A1
(43) Pub. Date: Nov. 28, 2024

(54) MULTI-FUNCTION SOCKET TOOL

(71) Applicant: Cramik Enterprises, Inc., Westerly, RI (US)

(72) Inventor: Greg Schonberg, Millbury, MA (US)

(73) Assignee: Cramik Enterprises, Inc., Westerly, RI (US)

(21) Appl. No.: 18/669,716

(22) Filed: May 21, 2024

Related U.S. Application Data
(60) Provisional application No. 63/468,427, filed on May 23, 2023.

(51) Int. Cl. B25B 13/06

(52) U.S. Cl. CPC B25B 13/06

(57) ABSTRACT

A multi-function double-ended socket tool for installation of a beam clamp includes a 7/16 inch twelve point shallow socket at one end to engage the mounting bolt head, and a 9/16 inch six point deep socket at the opposing end to fit over the mounting bolt head and engage the lock nut.

### CROSS-REFERENCE TO RELATED APPLICATIONS

This application is a non-provisional application filing which claims the benefit of U.S. Provisional Patent Application No. 63/468,427, filed May 23, 2023, the entire contents of which is incorporated herein by reference.

### BACKGROUND OF THE DISCLOSURE

(1) Field of the Invention: The instant invention relates to socket tools, and more particularly to a multi-function, double-ended socket tool having different socket depths and sizes at each end for use during installation of a beam clamp.

(2) Description of Related Art: Referring to FIGS. 1 and 2 (prior art), beam clamps 10 are known in the art, and include a generally C-Shaped clamp body 12 having a threaded bore opening 14 in the main body to receive a threaded hanger rod 16. A 7/16 inch mounting bolt 18 extends through a threaded opening in one of the arms of the clamp, and an accompanying 9/16 lock nut 20 is threaded onto the bolt 18 between the bolt head and the clamp arm.

During installation, the open mouth of the clamp 10 is positioned over the edge of a flange 22 of an overhead beam (top beam), the mounting bolt 18 is driven inwardly with a first socket tool to engage the clamp body 12 and mounting bolt 18 to the flange 22 thereby setting the clamp 10 in place. Thereafter, the lock nut 20 is driven into engagement with the head of the mounting bolt 18 with a second different size socket tool to lock the assembly in place.

Typically dozens, or hundreds, of these beam clamps 10 are installed into buildings to hang various pipe assemblies. Threaded hanger rod 16 is attached to the threaded bore at the top thereof and pipe hanger assemblies are hung at the bottom of the threaded rod.

As can be appreciated, the repeated interchange of two different socket tools during installation to the beam clamps is tedious and may in fact be dangerous since the installation is usually done at the top of a ladder or scaffolding, and if the socket tools are dropped or mishandled during the interchange, the dropped socket tool could injure someone below, not to mention the time lost retrieving the took from below.

Accordingly, there is a need for an improved socket tool to remedy the existing shortcomings of the prior art.

### SUMMARY OF THE DISCLOSURE

According to exemplary embodiments of the invention, a multi-function double-ended socket tool is provided which includes a 7/16 inch twelve point shallow socket at one end to engage the mounting bolt head, and a 9/16 inch six point deep socket at the opposing end to fit over the mounting bolt head and engage the lock nut.

A ¼ inch socket drive opening passes axially through the interior wall of the socket so it is accessible and functional from both ends of the socket. An extended length ¼ inch socket drive bit or head is particularly useful and facilitates interchange, i.e. flipping of the socket from one end to the other end during use. The ¼ drive bit may be installed into an impact gun, socket wrench or other suitable installation tool for use.

The sizes of the sockets can be varied at each end of the socket for other potential multi-function uses.

The socket drive opening can also be varied to ⅜ inch and ½ inch openings for other drive bits and bigger drive tools.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWINGS

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a perspective view of an exemplary prior art beam clamp;

FIG. 2 is another perspective view of the beam clamp installed on an overhead beam flange;

FIG. 3 is a top perspective view of an exemplary multi-function socket tool in accordance with the teachings of the present invention;

FIG. 4 is a bottom perspective view thereof;

FIG. 5 is a top view thereof;

FIG. 6 is a bottom view thereof; and

FIG. 7 is an illustration of the socket tool being used to sequentially tighten down the bolt and then secure the lock nut.

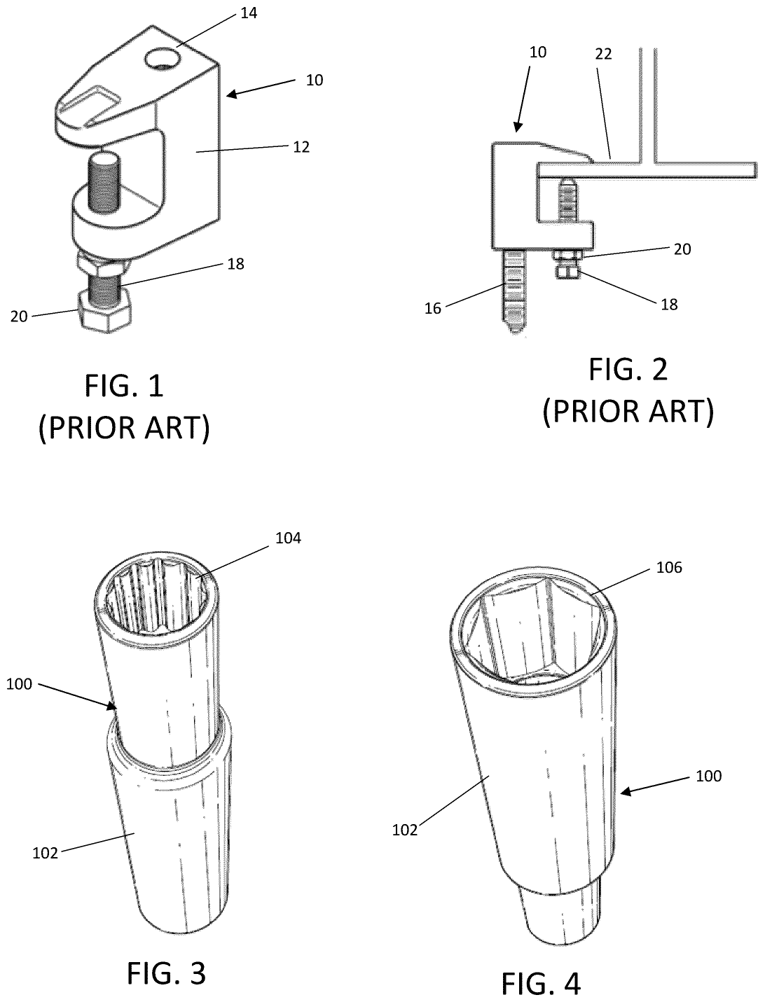

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

According to some exemplary embodiments of the invention, a multi-function, double-ended socket tool for installation of a beam clamp 10 having a mounting bolt and a lock nut comprises a shallow socket at one end to engage the mounting bolt head, and a deep socket at the opposing end to fit over the mounting bolt head and engage the lock nut. A socket drive opening passes axially through an interior wall of the socket so that the drive opening is accessible and functional from both ends of the socket.

An extended length socket drive bit or head (not shown) is particularly useful and facilitates interchange, i.e. flipping of the socket from one end to the other end during use.

The drive bit may be installed into an impact gun, socket wrench or other suitable installation tool for use (not shown).

The sizes of the sockets can be varied at each end of the socket for other potential multi-function uses.

The socket drive opening can also be varied to other size openings for other drive bits and bigger drive tools.

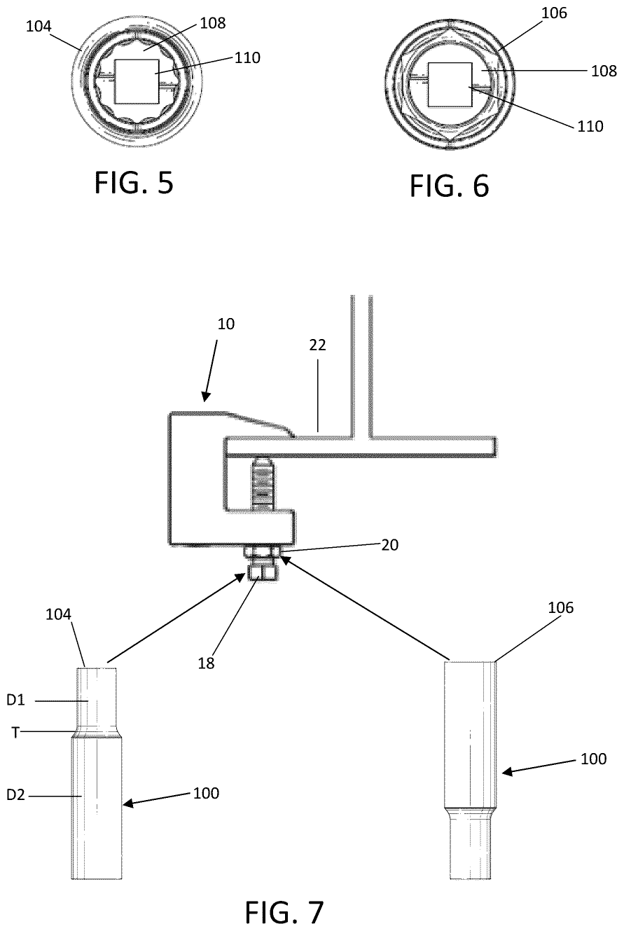

Referring now to FIGS. 3-7, an exemplary embodiment of the multi-function socket tool is illustrated and generally indicated at 100. The multi-function socket tool 100 is configured for the installation of a beam clamp 10 having a mounting bolt 18 with a 7/16 inch head and a 9/16 inch lock nut 20 threaded onto the mounting bolt. The socket tool 100 includes a elongated body 102 having a first end defining a 7/16 inch twelve point shallow socket 104 configured to engage the mounting bolt head 18, and further includes a second end defining a 9/16 inch six point deep socket 106 configured to fit over the mounting bolt head 18 and engage the 9/16 lock nut 20.

The elongated body has an interior socket wall 108 defining a bottom end of each of the 7/16 and 9/16 Inch Sockets 104, 106. The Interior Socket Wall 108 has a ¼ Inch Socket Drive opening 110 passing axially through the interior wall 108 of the tool 100 so it is accessible and functional from both ends of the socket tool 100.

The exterior surface of the elongated body has a first diameter D1 at the first end and a second larger diameter D2 at the second to facilitate visual recognition of the socket size, and a smooth chamfered transition area T therebetween.

As noted above, the sizes of the sockets 104, 106 can be varied at each end of the socket tool 100 for other potential multi-function uses and the socket drive opening 110 can also be varied to other size openings for other drive bits and/or bigger drive tools.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A multi-function socket tool for the installation of a beam clamp having a mounting bolt with a head having a first size and a lock nut having a second larger size threaded onto the mounting bolt, the multi-function socket too comprising:
an elongated body having a first end defining a shallow socket configured to engage the mounting bolt head, and further having a second end defining deep socket configured to fit over the mounting bolt head and engage the lock nut,
the elongated body having an interior socket wall defining a bottom end of each of the shallow and deep sockets, the interior socket wall having a socket drive opening passing axially through the interior wall of the socket so it is accessible and functional from both ends of the socket.

2. The multi-function socket of claim 1 wherein an exterior surface of the elongated body has a first diameter at the first end and a second larger diameter at the second, and a chamfered transition area therebetween.

3. A multi-function socket tool for the installation of a beam clamp having a mounting bolt with a 7/16 inch head and a 9/16 inch lock nut threaded onto the mounting bolt, the multi-function socket too comprising:
an elongated body having a first end defining a 7/16 inch twelve point shallow socket configured to engage the mounting bolt head, and further having a second end defining a 9/16 inch six point deep socket configured to fit over the mounting bolt head and engage the 9/16 lock nut,
the elongated body having an interior socket wall defining a bottom end of each of the 7/16 and 9/16 inch sockets, the interior socket wall having a ¼ inch socket drive opening passing axially through the interior wall of the socket so it is accessible and functional from both ends of the socket.

4. The multi-function socket of claim 3 wherein an exterior surface of the elongated body has a first diameter at the first end and a second larger diameter at the second, and a chamfered transition area therebetween.
